(19) United States
(12) Patent Application Publication
(10) Pub. No.: US 2011/0022737 A1
(43) Pub. Date: Jan. 27, 2011

(54) DEVICE CONTROL METHOD AND DEVICE SELECTING APPARATUS

(75) Inventors: Ryouichi KONO, Kyoto (JP); Shinichi EGASHIRA, Osaka (JP); Ryotaro SOYAMA, Kyoto (JP); Tomoya KAWAGUCHI, Kyoto (JP)

Correspondence Address: McDERMOTT WILL & EMERY LLP, 600 13th Street, N.W., Washington, DC, 20005-3096, US

(73) Assignee: PANASONIC CORPORATION, Osaka (JP)

(21) Appl. No.: 12/898,282

(22) Filed: Oct. 5, 2010

Related U.S. Application Data
(63) Continuation of application No. PCT/JP2009/001615, filed on Apr. 7, 2009.

(30) Foreign Application Priority Data
Apr. 7, 2008 (JP) 2008-099081

(51) Int. Cl. G06F 3/00

(52) U.S. Cl. 710/5

(57) ABSTRACT

A device control method which enables selection of a function of a USB device supporting multiple functions is provided. The device control method includes steps of obtaining device information from a USB device, determining, based on the obtained device information, whether command processing to issue a command to the USB device in order to detect functions of the USB device is required or not, performing the command processing if the command processing is determined to be required, creating device list information in which information on the functions of the USB device is listed based on both the obtained device information and a result of the command processing, and storing the device list information in a memory area.

### CROSS-REFERENCE TO RELATED APPLICATION

This is a continuation of PCT International Application PCT/JP2009/001615 filed on Apr. 7, 2009, which claims priority to Japanese Patent Application No. 2008-099081 filed on Apr. 7, 2008. The disclosures of these applications including the specifications, the drawings, and the claims are hereby incorporated by reference in its entirety.

### BACKGROUND

The present invention relates to device control programs and device selecting apparatuses, and more particularly to device selecting apparatuses having universal serial bus (USB) host functions, and control techniques for such device selecting apparatuses.

In recent years, an interface having a USB host function (USB host I/F) has been provided as a standard interface not only in personal computers (PCs) but also in multimedia devices such as audio-visual (AV) devices, and thus becoming more commonplace. Accordingly, USB devices have been increasingly used for connection to multimedia devices. Conventional USB devices, which have been used with PCs and multimedia devices, typically have only a single function. For example, a USB memory device supporting only a storage function is connected to a PC to perform data read/write operations between the PC and the USB memory device; or a USB memory device is connected to a multimedia device to reproduce or edit music data stored in the USB memory device.

However, as multifunctional USB devices have become popular, USB devices each supporting multiple functions in a single device have been becoming the mainstream, and thus the trend has been to connect a USB device supporting multiple functions also to a PC or a multimedia device. For example, it has become possible to use and connect a digital audio player, as a USB device, having both a storage function and a stream playback function to a multimedia device, to perform stream playback of music data stored in the digital audio player, and to write music data into the digital audio player. A related technology is disclosed, for example, in Japanese Patent Publication No. P2006-185218 (Patent Document 1).

### SUMMARY

When such a USB device supporting multiple functions is connected to a multimedia device, functions to be activated upon connection are often specified in advance, and thus the function which a user wants to use cannot be necessarily selected upon connection.

In addition, when a USB device supporting multiple functions is connected to a PC including a USB host I/F, the functions are not selected in a way such that only the function which a user want to use is selected, but all the functions supported by the PC will be activated. Thus, functions which a user does not want to use are often made available, which may allow the user to accidentally use a function which the user does not want to use, and thus may cause malfunction.

In order to solve these problems, a method using an authorization list is used as a method to limit the functions of a USB device used by connecting to a PC. FIG. 1 is a diagram illustrating an example configuration of a conventional authorization list. The authorization list includes regions for the number of devices 101 representing the number of devices, authorized devices 102 defining each of the authorized devices, and exception information 103. When a USB device is connected, the PC analyzes device information of the USB device, and compares a result with information of the authorization list. If the comparison result indicates a USB device having a function which a user wants to use, then a connection to the PC is allowed; while the comparison result indicates a USB device having a function which a user does not want to use, then a connection to the PC is restricted (see, e.g., Patent Document 1).

However, since in Patent Document 1, an authorization list is used for function determination of a device, setting more detailed connection conditions in the authorization list will allow the conditions of functions which the user wants to use to be set in more detail; meanwhile, as the conditions in the authorization list become more specific, the amount of information of the authorized devices 102 and the exception information 103 will increase, and thus a larger size of memory area is required to store the authorization list.

Additionally, in Patent Document 1, in order to change functions which a user wants to use upon connection of the USB device, the authorization list incorporated in advance in the system needs to be updated. Although the authorization list may be updated on a user-by-user basis, in order to update the authorization list on a user-by-user basis, a dedicated software tool for updating is required. Thus, in an environment having no resource limitations such as an environment of PC, a control program using an authorization list can be implemented; however, such a method is difficult to implement with a control program having an embedded resource-limited environment such as that of a multimedia device. This may present an issue.

Patent Document 1 presents another issue in that detection of a function supported by the connected USB device is performed using only one type of class information, and that it is assumed that only one function is supported. In Patent Document 1, the information used for detecting the function of a USB device is the class information in an INTERFACE_DESCRIPTOR obtained from the USB device upon connection.

FIG. 2 is a diagram illustrating a data structure of the INTERFACE_DESCRIPTOR. The INTERFACE_DESCRIPTOR includes nine bytes of data, and a field of bInterfaceClass 201 includes the class information. In Patent Document 1, only the class information of the bInterfaceClass 201 is used to detect the function supported by the device. Thus, for example, if a USB device is connected in which more than one type of class information collectively represent one function, or if a USB device is connected in which a function is detected considering a command processing result for detecting class information and a function, then the function of the USB device may be misidentified by the method of Patent Document 1.

Accordingly, it is preferable that a user can select a function which the user wants to use without using an authorization list, and that the functions supported by a USB device be not detected only by class information.

It is an object of the present invention to achieve selection of a function of a USB device which supports multiple functions, even in a resource-limited environment.

A device control method according to an embodiment of the present invention includes obtaining device information from a USB device; determining, based on the obtained device information, whether command processing to issue a command to the USB device in order to detect functions of the USB device is required or not, and performing the command processing if the command processing is determined to be required; creating device list information in which information on the functions of the USB device is listed based on both the obtained device information and a result of the command processing; and storing the device list information in a memory area.

This method allows a command to be issued to the USB device as necessary; therefore, the functions of the USB device can be correctly identified not only by class information.

A computer-readable medium according to an embodiment of the present invention stores computer-executable instructions for causing a computer programmed thereby to perform a method which includes obtaining device information from a USB device; determining, based on the obtained device information, whether command processing to issue a command to the USB device in order to detect functions of the USB device is required or not, and performing the command processing if the command processing is determined to be required; creating device list information in which information on the functions of the USB device is listed based on both the obtained device information and a result of the command processing; and storing the device list information in a memory area.

A device selecting apparatus according to an embodiment of the present invention includes a processing unit, and a USB host controller configured to transfer data between a USB device and the processing unit. The processing unit obtains device information from the USB device, determines, based on the obtained device information, whether command processing to issue a command to the USB device in order to detect functions of the USB device is required or not, performs the command processing if the command processing is determined to be required, creates device list information in which information on the functions of the USB device is listed based on both the obtained device information and a result of the command processing, and stores the device list information in a memory area.

The example embodiment of the present invention allows selection of a function of a USB device supporting multiple functions. Since there is no need to use a dedicated software tool to select a function, a function selection can be performed even in a resource-limited environment.

### BRIEF DESCRIPTION OF THE DRAWINGS

FIG. 1 is a diagram illustrating an example configuration of a conventional authorization list.

FIG. 2 is a diagram illustrating a data structure of the INTERFACE_DESCRIPTOR.

FIG. 3 is a block diagram illustrating a configuration of a device selecting apparatus according to an embodiment of the present invention.

FIG. 4 is a flowchart illustrating an example process of the device selecting apparatus shown in FIG. 3.

FIG. 5 is a flowchart illustrating a process of the device-information processing block.

FIG. 6 is a diagram illustrating an example data structure of the DEVICE_DESCRIPTOR.

FIG. 7A is a diagram illustrating an example of configuration information when the device has only one configuration. FIG. 7B is a diagram illustrating an example of configuration information when the device has a plurality of configurations.

FIG. 8 is a diagram illustrating an example of pattern information.

FIG. 9 is a flowchart illustrating a process of the list processing block before device list information is created.

FIG. 10 is a diagram illustrating an example of the device list information.

FIG. 11 is a flowchart illustrating a process from when the functions supported by the connected USB device are presented to the user until the device selecting apparatus controls a user-selected function.

FIG. 12 shows an example of on-screen information to be presented to the user.

FIG. 13 is a flowchart illustrating a process of the list processing block after the device list information is created.

FIG. 14 is a flowchart illustrating a process of the class processing block.

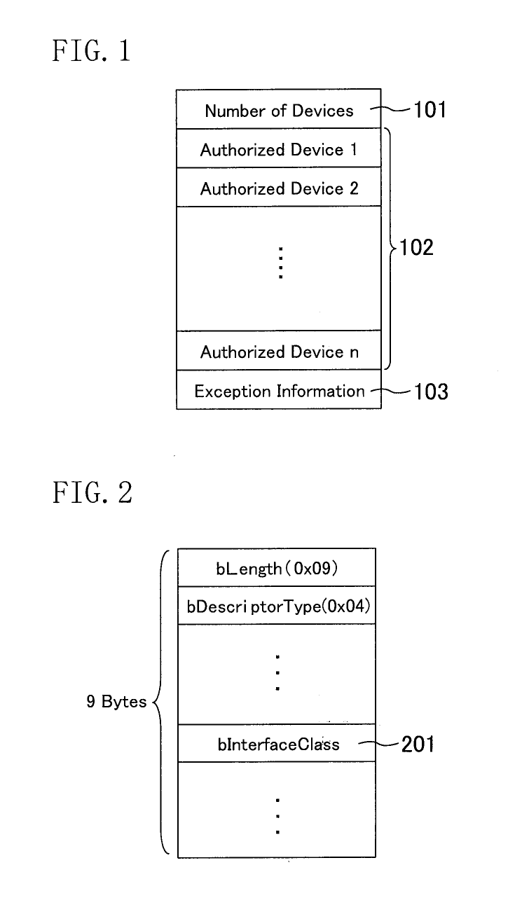

### DETAILED DESCRIPTION

### Overview

When a USB device which supports multiple functions is connected to a device selecting apparatus, the device selecting apparatus executes a control program, thereby performs the processes of the following steps a, b, c, and d.

When a USB device is connected, the device selecting apparatus obtains device information from the USB device in order to detect the functions supported by the USB device. The device selecting apparatus determines, from the obtained device information, whether the information on the functions supported by the USB device is information which can be detected only by class information in the INTERFACE_DESCRIPTOR, information which requires a combination of different types of class information to detect the functions, or information which requires command processing to detect the class information and the functions, based on pattern information for identifying the functions of the device. If the determination result indicates that the functions cannot be detected only by the class information in the INTERFACE_DESCRIPTOR, command processing is performed on the USB device for detecting the functions (step a).

Next, in consideration of the obtained device information and the result of command processing, the functions supported by the device are detected. Information on the detected functions is stored in a memory area in the device selecting apparatus in a form of device list information in which information to be presented to the user and information managed internally in the control program are associated with each other (step b).

If the device list information is properly created, the device selecting apparatus obtains information to present to the user from the device list information, and presents the types of functions supported by the USB device to the user using an output device of the device selecting apparatus. The user selects a function which the user wants to use from the presented functions of the device using an input device of the device selecting apparatus (step c).

The selected information is converted from the device list information into internally-managed information by the control program, and class processing required for controlling the user-selected function of the device is selected. After the class processing is selected, the device selecting apparatus performs configuration processing to determine a function to use on the USB device. After the configuration processing has been performed on the USB device, the device selecting apparatus controls the USB device using the class processing (step d).

Execution of the processes of steps a and b allows the functions supported by the USB device to be correctly identified even though the functions of the USB device are not detected only by the class information in the INTERFACE_DESCRIPTOR. In addition, execution of the processes of steps c and d allows the function which the user may want to use to be presented to the user, and the user to select a function, thereby allowing only the selected function of the USB device to be controlled.

According to the processes described above, since information to be managed is only the device list information, and the user selects the function of the USB device to be used, there is no need to create an authorization list defining detailed conditions of functions which the user wants to use, nor to implement a dedicated software tool to update the authorization list. This allows resources to be saved, and the method can be implemented even in an embedded resource-limited environment.

On function selection of the USB device, the supported functions can be explicitly presented to the user upon connection of the USB device; therefore, the user can select a function which the user wants to use. In addition, since only the function which the user wants to use is selected and activated upon connection of the USB device, a function which the user does not want to use is prevented from being operated, thus a malfunction by user operation can be prevented.

On function determination of the USB device, the functions of the USB device can be correctly determined even when the functions of the USB device cannot be detected only by the class information such as when a combination of different types of class information collectively represents a function, or when a function is determined in consideration of the result of command processing for identifying the class information and the function.

### Embodiment

An example embodiment of the present invention will be described below in detail with reference to the drawings.

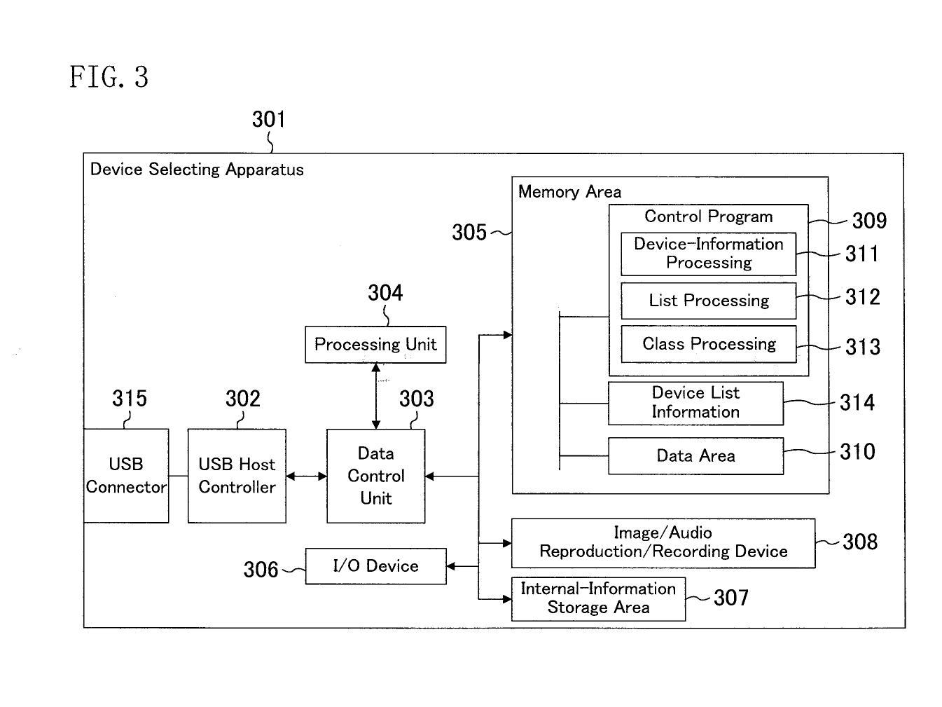

FIG. 3 is a block diagram illustrating a configuration of a device selecting apparatus according to an embodiment of the present invention. The device selecting apparatus 301 includes a USB host controller 302, a data control unit 303, a processing unit 304, a memory area 305, an input/output (I/O) device 306, an internal-information storage area 307, an image/audio reproduction/recording device 308, and a USB connector 315. Connection and disconnection of a USB device are made through the USB connector 315 of the device selecting apparatus 301.

Main features of the respective components of the device selecting apparatus 301 shown in FIG. 3 will now be described. The USB host controller 302 performs data send-receive processing with the USB device and data send-receive processing with the data control unit 303 while the USB device is connected to the USB connector 315.

The memory area 305 stores a control program 309 which controls the device selecting apparatus 301. The memory area 305 is also used for device list information 314 for temporarily storing information on the functions supported by the connected USB device, and for a data area 310 for temporarily storing data in processing of the control program.

The I/O device 306 presents information on the functions supported by the USB device to the user, and performs processing to allow the user to select a function of the USB device. The internal-information storage area 307 serves as a memory area for storing data sent from and data to be send to the USB device. The image/audio reproduction/recording device 308 analyzes the data sent from the USB device, and reproduces and records the data as image/audio data in the device selecting apparatus 301.

The processing unit (computer) 304 executes the control program 309 stored in the memory area 305, controls all the units included in the device selecting apparatus 301, including the data control unit 303, and performs access processing on data storage areas.

The data control unit 303 is controlled by the processing unit 304; the data control unit 303 performs data control of the USB host controller 302, data access to the memory area 305, control of the image/audio reproduction/recording device 308, data access to the internal-information storage area 307, and data control of the I/O device 306.

The control program 309 includes three main processing blocks: a device-information processing block 311, a list processing block 312, and a class processing block 313. The device-information processing block 311 is a processing block for obtaining device information and for performing command processing for function determination upon connection of a USB device. The list processing block 312 is a processing block for creating the device list information 314 from the device information obtained from the USB device, for outputting the device list information 314 to the user, and for determining corresponding class information from the function which the user has selected. The class processing block 313 is a processing block for controlling class driver processing, and includes a processing routine for configuring the function to be used in the USB device, and a class-driver processing routine for operating the user-selected function.

In this embodiment, when a USB device is connected to the device selecting apparatus 301, the device selecting apparatus 301 obtains information on the functions supported by the USB device, creates a list of the functions of the USB device based on the obtained information, stores the list as the device list information 314, presents the functions supported by the USB device to the user based on the stored device list information 314, and controls the function of the USB device according to the function selection made by the user.

Descriptions will be provided below individually on two operations: the operation of the device selecting apparatus 301 from when a USB device is connected to the device selecting apparatus 301 until a list of the functions supported by the USB device is created and stored as the device list information 314, and the operation of the device selecting apparatus 301 from when the functions supported by the USB device are presented to the user until the device selecting apparatus 301 controls the function of the USB device according to the function selection made by the user.

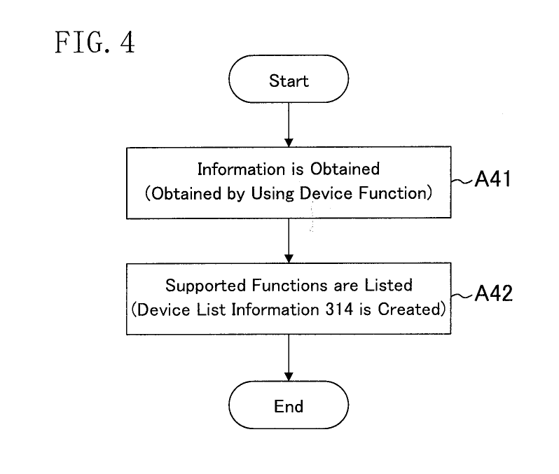

FIG. 4 is a flowchart illustrating an example process of the device selecting apparatus 301 shown in FIG. 3. FIG. 4 shows the process from when a USB device is connected to the device selecting apparatus 301 until a list of the functions supported by the USB device is created. At step A41, the processing unit 304 executes the device-information processing block 311 in the control program 309. Thus, the processing unit 304 obtains device information from the USB device when the USB device is connected to the device selecting apparatus 301.

Next, at step A42, the processing unit 304 executes the list processing block 312 in the control program 309. Thus, the processing unit 304 creates the device list information 314 in which information of the functions of the USB device is listed based on the obtained device information, and stores the device list information 314 in the memory area 305.

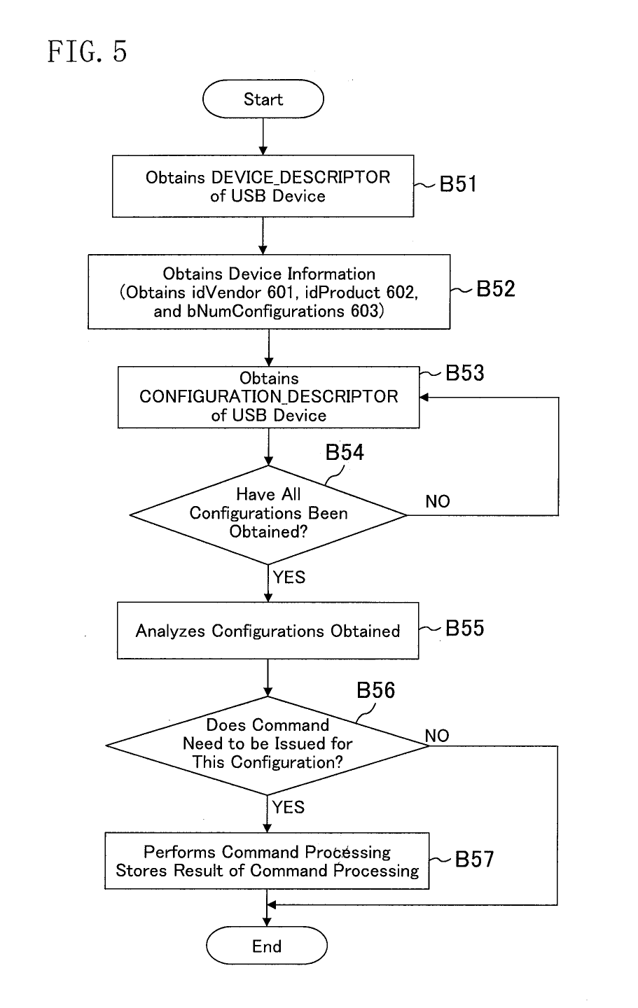

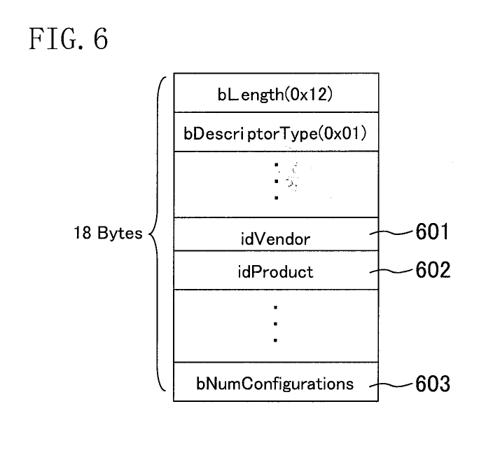

FIG. 5 is a flowchart illustrating a process of the device-information processing block 311. FIG. 5 corresponds to the process of step A41 to obtain device information of FIG. 4. FIG. 6 is a diagram illustrating an example data structure of the DEVICE_DESCRIPTOR. The DEVICE_DESCRIPTOR has eighteen bytes of data, which includes a value of idVendor 601 representing a manufacturer ID, a value of idProduct 602 representing a product ID, and a value of bNumConfigurations 603 representing a configurable number of devices.

When a USB device is connected to the device selecting apparatus 301, the USB host controller 302 becomes ready for communication with the USB device, and then first obtains the DEVICE_DESCRIPTOR in order to obtain configuration information of the USB device (step B51).

The processing unit 304 stores the information of the idVendor 601, the idProduct 602, and the bNumConfigurations 603, which are contained in the obtained DEVICE_DESCRIPTOR, in the data area 310 (step B52).

Then, the USB host controller 302 obtains the CONFIGURATION_DESCRIPTOR in order to obtain detailed configuration information of the USB device (step B53).

Information on the detailed configuration of the USB device is organized into information called “configuration information.” The USB device has as many configurations as the number indicated by the bNumConfigurations 603. The USB device may have one or more configurations. The configuration information can be obtained by obtaining the CONFIGURATION_DESCRIPTOR from the USB device. By obtaining the CONFIGURATION_DESCRIPTOR, the detailed configuration information of the USB device can be obtained.

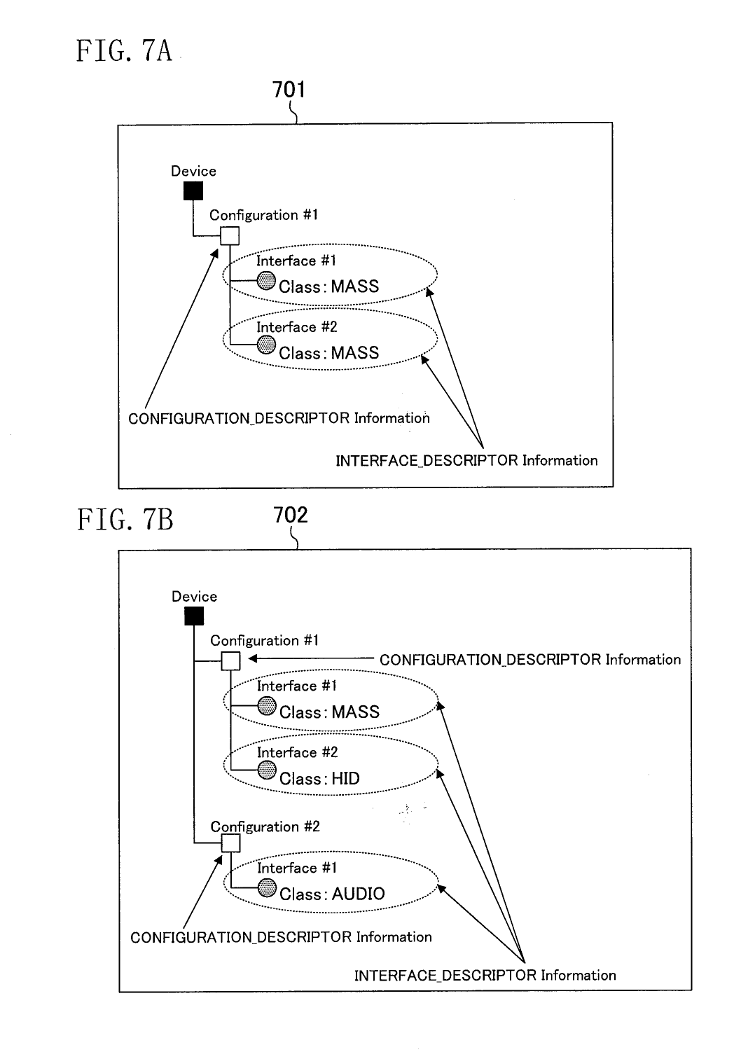

FIG. 7A is a diagram illustrating an example of configuration information when the device has only one configuration. FIG. 7B is a diagram illustrating an example of configuration information when the device has a plurality of configurations. As shown in the examples of the configuration information 701 of FIG. 7A and the configuration information 702 of FIG. 7B, when the CONFIGURATION_DESCRIPTOR is obtained, information of the INTERFACE_DESCRIPTOR can also be obtained; thus, the number of interfaces included in each configuration as well as class information can be obtained.

After the CONFIGURATION_DESCRIPTOR has been obtained, the processing unit 304 determines whether or not information on all the configurations has been obtained from the USB device using the value of the bNumConfigurations 603 obtained at step B52 (step B54).

If the USB device has a plurality of configurations as indicated by the configuration information 702, and it is determined that all the configuration information has not yet been obtained, the process returns to step B53. In this case, the USB host controller 302 once again obtains the CONFIGURATION_DESCRIPTOR from the USB device in order to obtain the remaining configuration information.

If it is determined that all the configuration information has been obtained, the processing unit 304 analyzes all the obtained configuration information, and sees whether functions undetectable by only the class information (referred to hereinafter as “special functions”) may or may not be included in the USB device (step B55). The analysis at step B55 is performed based on pattern information on special functions included in the device-information processing block 311.

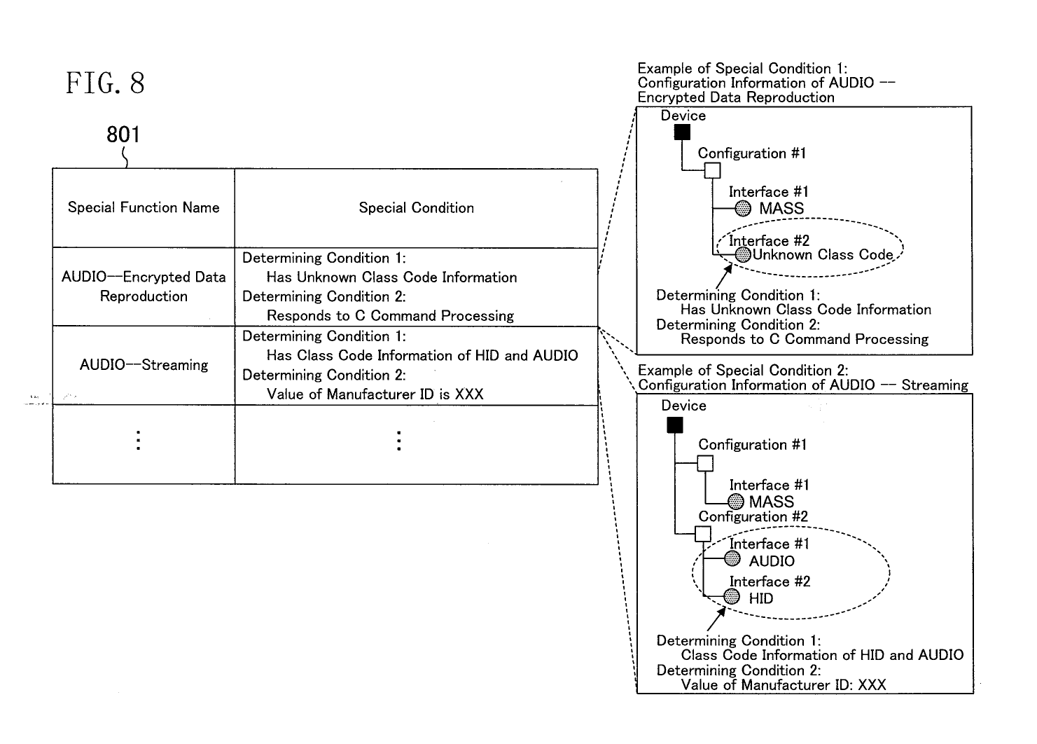

FIG. 8 is a diagram illustrating an example of pattern information. The pattern information 801 includes special function names representing the names of special functions and special conditions for determining special functions. The special conditions define conditions for determining special functions. Each of the special conditions includes information obtainable from the DEVICE_DESCRIPTOR and the CONFIGURATION_DESCRIPTOR, and information representing command processing to detect the special functions of the USB device. The pattern information 801 is included in advance in the device-information processing block 311 depending on the special functions supported by the device selecting apparatus 301.

Using a result of the analysis at step B55, the processing unit 304 determines whether or not the USB device has any special functions which cannot be detected only by class information, in other words, whether command processing to issue a command to the USB device is required or not in order to detect the special functions (step B56).

If it is determined that command processing is not required, the process flow of FIG. 5 terminates. If it is determined that command processing is required, that is, if the USB device has one or more special functions which cannot be detected only by class information, the processing unit 304 selects command processing from the special conditions described in the pattern information 801, performs the command processing, and stores a process result in the data area 310 (step B57). After the process of step B57 is executed, the process flow of FIG. 5 terminates. Thus, the above description has described the process flow of the device-information processing block 311, executed by the processing unit 304, to obtain the device information from the USB device.

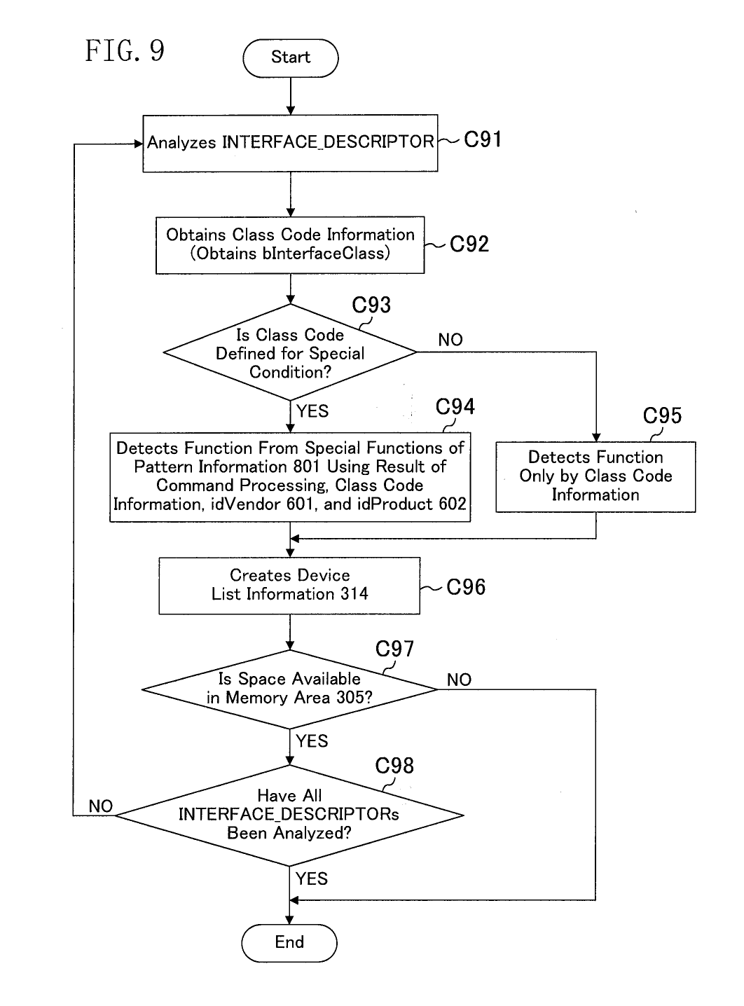

FIG. 9 is a flowchart illustrating a process of the list processing block 312 before device list information 314 is created. FIG. 9 corresponds to the process of step A42 of FIG. 4. The processing unit 304 analyzes the INTERFACE_DESCRIPTOR information from the device information obtained in the process of FIG. 5 (step C91). The processing unit 304 obtains information of the bInterfaceClass 201, which is class information, from the analyzed INTERFACE_DESCRIPTOR information (step C92).

The processing unit 304 determines whether or not the class information obtained at step C92 satisfies any of the special conditions of the pattern information 801 in the device-information processing block 311 (step C93).

If it is determined that the class information obtained at step C92 satisfies one of the special conditions, the processing unit 304 selects a special function from the pattern information 801 and detects the functions of the USB device, using information of the idVendor 601 and the idProduct 602, the result of the command processing, and the class information (step C94).

If it is determined that the class information obtained at step C92 does not satisfy any of the special conditions, the processing unit 304 detects the functions of the USB device only by the class information (step C95).

After the process at step C94 or C95, the processing unit 304 compiles information on the functions of the USB device to create the device list information 314, and stores the device list information 314 in the memory area 305 (step C96).

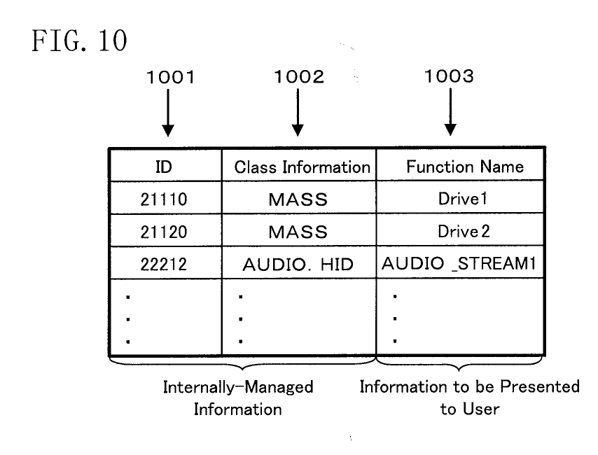

FIG. 10 is a diagram illustrating an example of the device list information 314. The device list information 314 stored in the memory area 305 will now be described using FIG. 10. The device list information 314 includes internally-managed information managed internally in the control program 309 and information to be presented to the user for displaying the functions supported by the USB device to the user using the I/O device 306.

The internally-managed information includes IDs 1001 assigned to the respective functions of the USB device, and class information 1002 of the class driver processing routines in the class processing block 313 required for function management for the device. The IDs 1001 and the class information 1002 are managed in association with each other. Each of the IDs 1001 is formed of information obtainable from the DEVICE_DESCRIPTOR, information obtainable from the INTERFACE_DESCRIPTOR, and information obtainable from the CONFIGURATION_DESCRIPTOR. Therefore, by analyzing an ID 1001, the configuration information of device, such as the number of configurations and the number of interfaces as shown in the configuration information 701 and in the configuration information 702 can be identified.

The information to be presented to the user is formed of the function names 1003 of the functions supported by the USB device. The internally-managed information and the information to be presented to the user are associated with each other by three kinds of information: the IDs 1001, the class information 1002, and the function names 1003. Thus, the information to be presented to the user can be searched from the internally-managed information, and the internally-managed information can be searched from the information to be presented to the user.

The device list information 314 is created in the memory area 305 by a process of the list processing block 312 depending on the functions of the USB device when the USB device is connected to the device selecting apparatus 301. When the USB device is disconnected, the device list information 314 corresponding to the USB device is deleted from the memory area 305.

After creating the device list information 314 at step C96, the processing unit 304 checks the remaining capacity of the memory area 305. If the result of memory availability check shows that the memory area 305 has sufficient available space, then the processing unit 304 executes the next process, while if the result shows that the memory area 305 does not have sufficient available space, then the processing unit 304 terminates the process flow of FIG. 9 (step C97).

The size of the memory area 305 to store the device list information 314 needs to be adjusted depending on the system specification. If searches for many functions of a USB device need to be performed, then a large area needs to be made available in advance for the memory area 305 to store the device list information 314, while if searches for many functions of a USB device do not need to be performed, and the memory size to be used is preferably small, then a small area is made available for the memory area 305. If it is determined that the memory area 305 has sufficient available space at step C97, then the processing unit 304 determines whether or not all the INTERFACE_DESCRIPTOR information has been analyzed (step C98).

If it is determined that searches for all the INTERFACE_DESCRIPTOR information have not yet completed, the processing unit 304 returns the process to step C91, analyzes the INTERFACE_DESCRIPTOR information, and adds the functions supported by the USB device to the device list information 314. If it is determined that all the INTERFACE_DESCRIPTOR information has been analyzed, then the processing unit 304 terminates the process flow of FIG. 9. Thus, the above description has described the process flow of the list processing block 312, executed by the processing unit 304, to create the device list information 314 based on the information obtained from the USB device.

There has thus been described the operation of the device selecting apparatus 301 from when a USB device is connected to the device selecting apparatus 301 until the functions supported by the USB device is listed using FIGS. 4, 5, and 9. The process flows shown in FIGS. 4, 5, and 9 allow the functions supported by the device to be correctly detected even when the functions of a USB device cannot be detected only by class information in the INTERFACE_DESCRIPTOR.

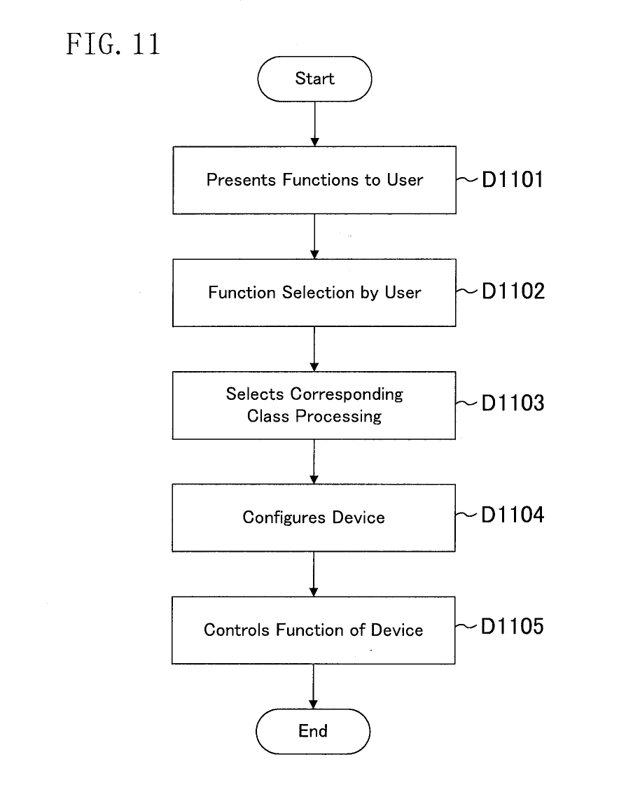

After this, the process of FIG. 11 is executed. FIG. 11 is a flowchart illustrating a process from when the functions supported by the connected USB device are presented to the user until the device selecting apparatus 301 controls the user-selected function. When creation of the device list information 314 is completed, the functions supported by the USB device are presented to the user. That is, the I/O device 306 displays information on the functions supported by the USB device using the function names 1003 in the device list information 314 (step D1101).

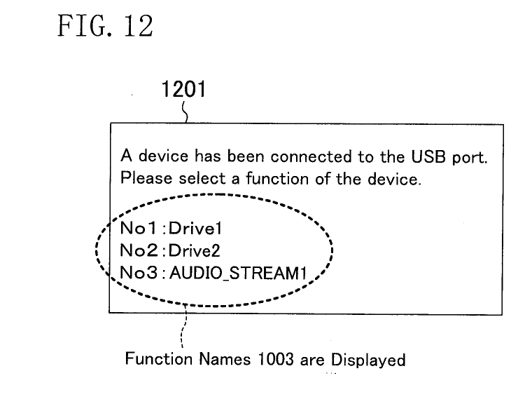

FIG. 12 shows an example of on-screen information 1201 presented to the user. As shown in FIG. 12, the processing unit 304 arranges for only information of the function names 1003 in the device list information 314 to be displayed as the information on the functions supported by the USB device. The user selects a function to use from the presented on-screen information 1201, using the I/O device 306 (step D1102). The processing unit 304 replaces the input information representing the selected function, input from the I/O device 306, with the class information 1002 using the device list information 314, and selects a class driver processing routine in the class processing block 313 to control the function corresponding to the class information 1002 (step D1103). That is, the processing unit 304 selects a function of the USB device based on the input information.

When a class driver processing routine is selected, the processing unit 304 configures the configuration information used for the USB device, and activates the selected function of the USB device (step D1104). After the configuration information to be used for the USB device has been configured, the processing unit 304 starts class driver processing to control the user-selected function, and controls the function of the USB device (step D1105). The process of steps D1101-D1103 is performed by the processing unit 304 in executing the list processing block 312, and the process of steps D1104-D1105 is performed by the processing unit 304 in executing the class processing block 313.

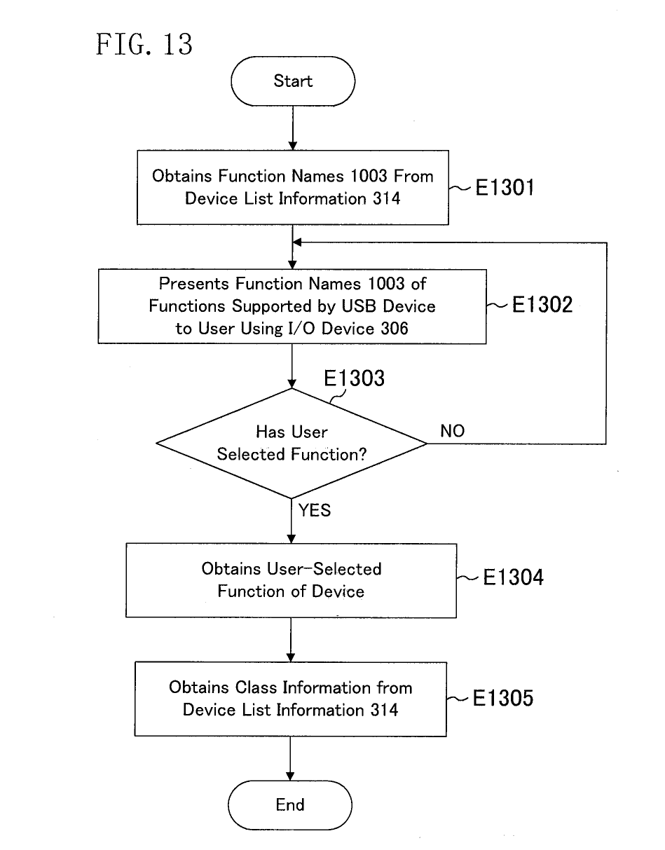

FIG. 13 is a flowchart illustrating a process of the list processing block 312 after the device list information 314 is created. The list processing block 312 presents the functions of the USB device to the user, and allows the user to dynamically select a function of the device.

First, the processing unit 304 obtains the function names 1003 from the device list information 314 (step E1301). The obtained function names 1003 are transmitted from the data control unit 303 to the I/O device 306, and the I/O device 306 displays the obtained function names 1003 to the user as the on-screen information 1201 (step E1302). The process at step E1302 allows the user to dynamically select a function of the device from the displayed on-screen information 1201. After the process at step E1302, the processing unit 304 determines whether or not the user has selected a function using the I/O device 306 (step E1303).

If it is determined that the user has not selected a function, the process at step E1302 is once again executed. If it is determined that the user has selected a function through the I/O device 306, the data control unit 303 transmits data on the user-selected function from the I/O device 306 to the processing unit 304 (step E1304).

The processing unit 304 analyzes the function data indicating the user-selected function and the function names 1003 of the device list information 314, and converts the function data to the class information 1002 of the device list information 314. The processing unit 304 selects a class driver processing routine in the class processing block 313 to control the user-selected function, according to the class information 1002 (step E1305). The process of steps E1301-E1304 is performed by the processing unit 304 in executing the list processing block 312 in the control program 309, and the process of step E1305 is performed by the processing unit 304 in executing the class processing block 313.

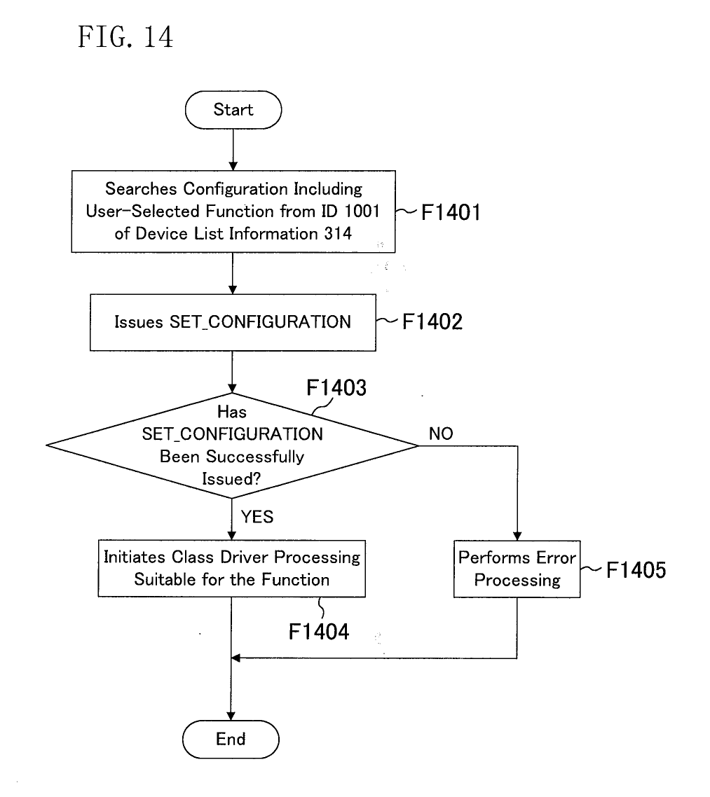

FIG. 14 is a flowchart illustrating a process of the class processing block 313. The class processing block 313 performs class processing in which the user-selected function is configured in the USB device, and in which the USB device is controlled. The process of FIG. 14 is executed after the process of FIG. 13 is completed.

After obtaining a class driver processing routine in the class processing block 313 according to the class information 1002 of the device list information 314, the processing unit 304 identifies the configuration including the user-selected function based on the ID 1001 corresponding to the class information 1002. Since each of the IDs 1001 is formed of information obtainable from the DEVICE_DESCRIPTOR, information obtainable from the INTERFACE_DESCRIPTOR, and information obtainable from the CONFIGURATION_DESCRIPTOR, the configuration including the user-selected function of the USB device can be searched (step F1401).

After the configuration including the user-selected function of the USB device has been searched, the USB host controller 302 issues a SET_CONFIGURATION request in the class processing block 313 to the USB device concerning the configuration including the function which the user wants to use (step F1402). Issuance of the SET_CONFIGURATION request to the USB device activates the configuration specified by the SET_CONFIGURATION request in the USB device. After the process at step F1402, the processing unit 304 determines whether or not the SET_CONFIGURATION request has been successfully issued (step F1403).

If the issuance of SET_CONFIGURATION is determined to have been failed, the processing unit 304 performs error processing to inform the user that the USB device is out of service using the I/O device 306, and the process flow of the class processing block 313 terminates (step F1405). If the issuance of SET_CONFIGURATION is determined to have been successful, the processing unit 304 starts to control the function of the USB device using a class driver processing routine suitable for the function of the USB device included in the class processing block 313 (step F1404).

Once the control of USB device is started, the user-selected function of the USB device enables the device selecting apparatus 301 to provide control such that the image/audio reproduction/recording device 308 reproduces and records image and audio information in the USB device, that the data in the USB device is stored in the internal-information storage area 307, and that the data stored in the internal-information storage area 307 is transferred to the USB device. The process shown in FIG. 14 is performed by the processing unit 304 in executing the class processing block 313.

In this way, by executing the processes shown in FIGS. 11, 13, and 14, the device selecting apparatus 301 presents the listed functions of the USB device to the user, and controls the user-selected function of the USB device. This allows the user to dynamically select a function from the presented functions.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

As described above, according to the example embodiments of the present invention, since a function of a USB device can be selected, the present invention is useful for device selection methods etc. The present invention is also useful for multimedia devices such as stereo component systems, digital versatile disc (DVD) players, hard disk drive (HDD) recorders, digital television sets, etc.

What is claimed is:

1. A device control method, comprising:
obtaining device information from a universal serial bus (USB) device;
determining, based on the obtained device information, whether command processing to issue a command to the USB device in order to detect functions of the USB device is required or not, and performing the command processing if the command processing is determined to be required;
creating device list information in which information on the functions of the USB device is listed based on both the obtained device information and a result of the command processing; and
storing the device list information in a memory area.

2. The device control method of claim 1, further comprising:
displaying the functions of the USB device using the device list information;
selecting the function of the USB device based on input information; and
activating the selected function of the USB device.

3. The device control method of claim 2, further comprising:
converting data representing the selected function of the USB device to class information corresponding to the selected function of the USB device.

4. The device control method of claim 3, further comprising:
performing class processing for configuring and controlling the selected function in the USB device.

5. The device control method of claim 1, wherein
the command processing is performed when the USB device has a function which cannot be detected by class information of the obtained device information.

6. The device control method of claim 1, wherein
in the device list information, information for displaying the functions of the USB device and management information are associated with each other.

7. A computer-readable medium storing computer-executable instructions for causing a computer programmed thereby to perform a method comprising:
obtaining device information from a USB device;
determining, based on the obtained device information, whether command processing to issue a command to the USB device in order to detect functions of the USB device is required or not, and performing the command processing if the command processing is determined to be required;
creating device list information in which information on the functions of the USB device is listed based on both the obtained device information and a result of the command processing; and
storing the device list information in a memory area.

8. A device selecting apparatus, comprising:
a processing unit; and
a USB host controller configured to transfer data between a USB device and the processing unit,
wherein
the processing unit obtains device information from the USB device,
determines, based on the obtained device information, whether command processing to issue a command to the USB device in order to detect functions of the USB device is required or not, and performs the command processing if the command processing is determined to be required,
creates device list information in which information on the functions of the USB device is listed based on both the obtained device information and a result of the command processing, and
stores the device list information in a memory area.
